(19) United States
(12) Patent Application Publication
(10) Pub. No.: US 2003/0016799 A1
(43) Pub. Date: Jan. 23, 2003

(54) Systems and methods to facilitate a communication associated with a destination identifier

(76) Inventors: Edith H. Stern, Yorktown Heights, NY (US); David P. Greene, Ossining, NY (US); Barry E. Willner, Briarcliff Manor, NY (US); Philip Shi-lung Yu, Chappaqua, NY (US)

Correspondence Address: BUCKLEY, MASCHOFF, TALWALKAR, & ALLISON, 5 ELM STREET, NEW CANAAN, CT, 06840, US

(21) Appl. No.: 09/908,135

(22) Filed: Jul. 18, 2001

(51) Int. Cl. H04M 15/00; H04M 1/56; H04M 15/06

(52) U.S. Cl. 379/120; 379/114.01; 379/114.13; 379/114.27; 379/115.01; 379/114.05; 379/127.01; 379/142.01

(57) ABSTRACT

Systems and methods are provided to facilitate a communication associated with a destination identifier. According to one embodiment, a request to facilitate a communication in association with a destination identifier is received from a party, the destination identifier having a primary purpose other than communication. The destination identifier may comprise, for example, an automobile license plate number or a Social Security number. Information is then transmitted to enable the requested communication. For example, a message from a requesting party may be forwarded to an electronic mail address associated with a license plate number.

### FIELD

The present invention relates to communication systems. In particular, the present invention relates to systems and methods to facilitate a communication associated with a destination identifier.

### BACKGROUND

People often want to communicate with others. For example, a person may want to send an electronic mail message to his or her friend. In this case, the person typically uses a communication address (i.e., an electronic mail address) to send information to the friend. Similarly, a person may use a telephone number or any other type of communication address to exchange information with someone else. The increasing use of communication devices and the growing variety of available devices (e.g., wireless telephones, and message-capable pagers) have only increased the public's ability, and desire, to communicate.

Sometimes, however, a communication address required to communicate with a particular person or device will not be known. For example, someone may want to send an electronic mail message to a person's wireless Personal Digital Assistant (PDA)—but not know that person's electronic mail address.

In response to this problem, it has been suggested that a first communication address associated with a person be translated into a second communication address associated with that person. For example, a voice message provided via a person's telephone number (i.e., the first communication address) may be automatically forwarded by a service provider to that person's electronic mail address (i.e., the second communication address). Once system for translating between communication addresses is disclosed, for example, in U.S. Pat. No. 6,064,666 entitled “Cross Service Common User Image Association,” the entire contents of which are incorporated herein by reference.

It is possible, however, that no communication address associated with a particular person will be known. For example, someone may want to send an electronic mail message to an owner of an automobile that is parked at a particular location. In this case, there may be no efficient method of determining a communication address associated with the owner.

### SUMMARY

To alleviate problems inherent in the prior art, the present invention introduces systems and methods to facilitate a communication associated with a destination identifier.

According to one embodiment, a request to facilitate a communication in association with a destination identifier is received, the destination identifier having a primary purpose other than communication. Information is then transmitted to enable the communication.

According to another embodiment, a request to facilitate a communication is received from a consumer, the request including a license plate number. An electronic mail address associated with the license plate number is determined, and information is transmitted to enable the communication between the consumer and the electronic mail address. It is also arranged for the consumer to provide payment of a monetary payment.

Another embodiment is directed to a method performed by a party, such as a consumer. According to this embodiment, a request to facilitate a communication is transmitted, the request including a destination identifier having a primary purpose other than communication. It is then arranged to provide payment in exchange for having the communication enabled.

According to still another embodiment, a communication request is received from a sender. The communication request includes both a sender communication address and a destination identifier having a primary purpose other than communication. The sender communication address is then transmitted to a destination communication address associated with the destination identifier.

In yet another embodiment, a request to facilitate a communication associated with a destination identifier is received from a first party, the destination identifier being associated with a second party and having a purpose other than communication. A destination communication address associated with the second party is determined, and information associated with the destination communication address is transmitted to enable communication between the first party and the second party.

One embodiment of the present invention comprises: means for receiving from a party a request to facilitate a communication in association with a destination identifier, the destination identifier having a primary purpose other than communication; and means for transmitting information to enable the communication.

Another embodiment comprises: means for receiving from a consumer a request to facilitate a communication, the request including a license plate number; means for determining an electronic mail address associated with the license plate number; means for transmitting information to enable the communication between the consumer and the electronic mail address; and means for arranging for the consumer to provide payment of a monetary payment.

Another embodiment comprises: means for transmitting a request to facilitate a communication, the request including a destination identifier having a primary purpose other than communication; and means for arranging to provide payment in exchange for having the communication enabled.

Still another embodiment comprises: means for receiving from a party a communication request including a party communication address and a destination identifier having a primary purpose other than communication; and means for transmitting the party communication address to a destination communication address associated with the destination identifier.

Yet another embodiment comprises: means for receiving from a first party a request to facilitate a communication associated with a destination identifier, the destination identifier being associated with a second party and having a purpose other than communication; means for determining a destination communication address associated with the second party; and means for transmitting information associated with the destination communication address to enable communication between the first party and the second party.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram overview of a communication system according to an embodiment of the present invention.

FIG. 2 is a flow chart of a method according to an embodiment of the present invention.

FIG. 3 is a block diagram overview of a communication system according to another embodiment of the present invention.

FIG. 4 is an information flow diagram according to an embodiment of the present invention.

FIG. 5 is an information flow diagram according to another embodiment of the present invention.

FIG. 6 is a block diagram of a communication controller according to an embodiment of the present invention.

FIG. 7 is a tabular representation of a portion of a destination information database according to an embodiment of the present invention.

FIG. 8 is a tabular representation of a portion of a communication request database according to an embodiment of the present invention.

FIG. 9 is a flow chart of a computer-implemented method to facilitate an electronic mail message communication associated with an automobile license plate number according to an embodiment of the present invention.

### DETAILED DESCRIPTION

Embodiments of the present invention are associated with systems and methods to facilitate “communication.” As used herein, the term “communication” may refer to any exchange of information or data. For example, a communication may comprise text information, audio information, visual information (e.g., graphical or video information), and/or executable information (e.g., a Java applet). Note that a communication may be associated with a person, an organization, and/or a device.

In some embodiments, a communication is facilitated using a destination identifier having a “primary purpose” other than communication. That is, the primary purpose of the destination identifier associated with a person (or a device) is something other than communication with that person (or that device). Thus, a license plate number or Social Security number may be considered destination identifiers having a primary purpose other than communication (e.g., of identifying an automobile and a person, respectively), while a telephone number or an electronic mail address would not.

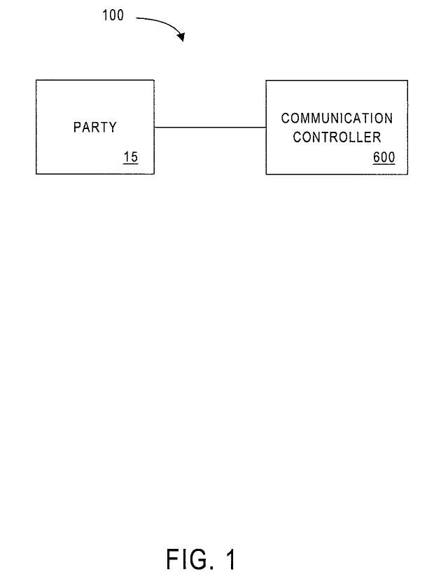

Turning now in detail to the drawings, FIG. 1 is a block diagram of a communication system 100 according to an embodiment of the present invention. As shown in FIG. 1, a party 15 may communicate with a communication controller 600. For example, the party 15 (e.g., a customer who subscribes to a communication facilitation service) may transmit to the communication controller 600 a request to facilitate a communication in association with a destination identifier, the destination identifier having a primary purpose other than communication. For example, the party 15 may want to communicate with a driver of an automobile, and use his or her wireless telephone to transmit a request to the communication controller 600 including the automobile's license plate number. The communication controller 600 could then forward a message from the party 15 to the driver of the automobile (e.g., via an electronic mail message associated with the license plate number). According to another embodiment, the communication controller 600 instead returns a communication address associated with the driver (e.g., his or her wireless telephone number) back to the party 15.

As in the above example, the “destination identifier” sent from the party 15 to the communication controller 600 may be an automobile identifier, such as a license plate number. An automobile may also be identified, for example, via a Vehicle Identification Number (VIN), a third-party identifier (e.g., such as an E-ZPASS^{SM} identifier or a bumper sticker), or other information (e.g., an automobile's manufacturer, model, color, and/or current location). Moreover, communications associated with other types of vehicles (e.g., boats and airplanes) may be facilitated in accordance with the present invention.

According to another embodiment, the party 15 transmits a governmental identifier, such as a Social Security number, to the communication controller 600. A payment identifier (e.g., a credit card, debit card, or back account number or digital payment protocol information) may be used as a destination identifier. According to another embodiment, biological information is used as a destination identifier. For example, the party 15 may submit a communication request indicating genetic information (e.g., DNA information), a facial image, a retinal pattern, a fingerprint, and/or a voice print.

The communication controller 600 may arrange for the party 15 to communicate via a “communication address” associated with the destination identifier. For example, the communication controller 600 may arrange for the party 15 to communicate via an electronic mail address. Other types of communication addresses include, for example, an instant message address, an Internet Protocol address, a wireless or wired telephone number, a postal address, and Bluetooth information.

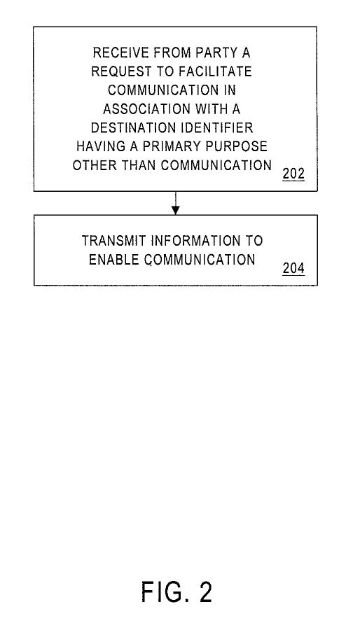

FIG. 2 is a flow chart of a method according to an embodiment of the present invention. The flow charts in FIG. 2 and the other figures described herein do not imply a fixed order to the steps, and embodiments of the present invention can be practiced in any order that is practicable. The method shown in FIG. 2 may be performed, for example, by the communication controller 600.

At 202, a request to facilitate a communication in association with a destination identifier is received from a party. According to an embodiment of the present invention, the destination identifier has a primary purpose other than communication. Consider, for example, a first driver who wants to communicate with a second driver. In this case, the request may be received from the first driver's wireless PDA via a Web site (e.g., a Web site associated with a communication controller 600). The request may include, for example, a short message written by the first driver and a license plate number (i.e., the destination identifier) of the automobile being driven by the second driver.

When a destination identifier is associated with an automobile, such a request may also be generated, for example, when the automobile is located at a pre-determined area (e.g., is parked in a particular parking lot). The request may also be generated when the automobile moves through a pre-determined area (e.g., a particular intersection) and/or satisfies a pre-determined condition. (e.g., is moving in a particular direction, is subject to a manufacturer's recall, and/or exceeds a local speed limit).

The request may be received from any party, including an advertiser or an enterprise (e.g., a merchant that wants to send an advertisement to all drivers that pass through a particular intersection) or a consumer (e.g., who wants to receive more information about an advertisement). The request may also be received from, for example, a governmental authority or a security service (e.g., that wants to send a notification to all people who have driven through a particular intersection during the past five days).

The destination identifier included in the request may comprise, for example, text information (e.g., indicating a license plate number and an associated jurisdiction), audio information (e.g., speech information), and/or image information (e.g., a picture of an automobile).

In addition to the destination identifier, the request may include a message that the party would like to communicate (e.g., including text, audio, image, and/or advertisement information). The request may also include a communication address preference. For example, a party might indicate that he or she prefers to have a message delivered via a wireless telephone. The request may also include an identifier of the party associated with the request (e.g., his or her real name or “nickname”) and/or a communication address of the party. For example, a first driver may simply request to have his or her wireless telephone number provided to a second driver. The request may also include payment information (e.g., to arrange to provide payment in exchange for having a communication enabled).

At 204, information is transmitted to enable the communication in accordance with the request. For example, the communication controller 600 may transmit a message (e.g., a message that was included in the request) to a communication address associated with the destination identifier (e.g., to an electronic mail address associated with a license plate number). Note that the communication controller 600 may first need to determine the communication address based on the destination identifier (e.g., by retrieving a pre-stored communication address using the destination identifier or by receiving the communication address from a third-party service).

According to one embodiment, the communication controller 600 also determines supplemental information associated with the destination identifier. The supplemental information may comprise, for example, demographic information, preference information (e.g., indicating how someone would like to receive a communication), location information (e.g., a current location of an automobile), location history information (e.g., how many times an automobile was located in a particular merchant's parking lot during the past thirty days), and/or activity information (e.g., a speed of an automobile). The supplemental information may be, for example, transmitted from the controller 600 (e.g., to any other party or device described herein).

A particular destination identifier may be associated with a particular communication address (e.g., an automobile's license plate number may be associated with the telephone number of a wireless telephone installed in the automobile). A destination identifier may also be associated with a pre-determined destination party (e.g., an owner of a fleet of taxicabs) and/or a set of destination parties (e.g., a list of people who typically drive an automobile).

Note that a single destination identifier can be associated with a number of different communication addresses. For example, a license plate number may be associated with both a wireless telephone number and an electronic mail address. Similarly, a number of different destination identifiers can be associated with a single communication address. For example, a license plate number and a Social Security number may be associated with an electronic mail address.

According to one embodiment, the communication controller 600 or a third-party service determines whether or not a particular communication will be enabled based on the destination identifier. For example, some drivers may indicate that they do not want to receive messages from other drivers. Similarly, drivers may be required to register with a service before they are allowed to send and/or receive messages.

According to one embodiment, this determination is based on a preference associated with the destination identifier. According to another embodiment, this determination is further based on a communication address associated with the destination identifier. For example, a single destination identifier (e.g., a license plate) may be associated with two communication identifiers (e.g., a husband and wife associated with an automobile), and communications may be enabled for only one of the communication identifiers.

Communication System Overview

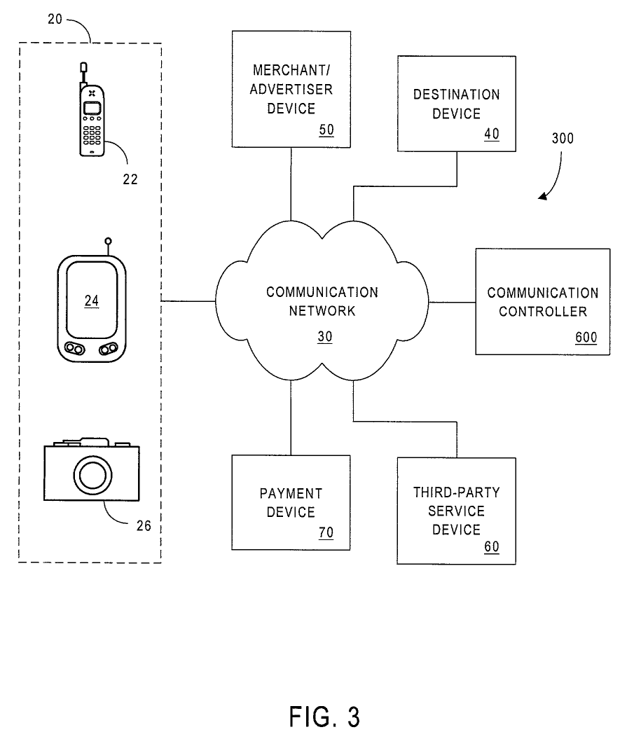

FIG. 3 is a block diagram of a communication system 300 according to another embodiment of the present invention. The communication system 300 includes a communication controller 600 in communication with a number of communication devices 20. As used herein, devices (such as the communication controller 600 and the communication devices 20) may communicate via a communication network 30, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless LAN (e.g., in accordance with the Institute of Electrical and Electronics Engineers 802.11 standard), a Bluetooth network, an Infrared Radiation (IR) network, and/or an IP network such as the Internet, an intranet or an extranet. As used herein, the term “communications” can refer to wired and/or wireless communications as appropriate. Note that the devices shown in FIG. 3 need not be in constant communication. For example, the communication controller 600 may communicate with a communication device 20 on an as-needed or periodic basis.

Although a single communication controller 600 is shown in FIG. 3, any number of communication controllers 600 may be included in the communication system 300. Similarly, any number of communication devices 20, or any of the other devices described herein, may be included in the communication system 300 according to embodiments of the present invention.

The communication controller 600 and the communication devices 20 may be any devices capable of performing the various functions described herein. A communication device 20 may be, for example: a wireless telephone 22, a PDA 24, or an information recording device 26 (e.g., a digital camera). Other examples of communication devices 20 include a Personal Computer (PC), a portable computing device (e.g., a laptop computer), a wired telephone, a kiosk (e.g., located at a service station), an interactive television device, and a one-way or two-way pager. A communication device 20 may be associated with any party who wants to communicate via a destination identifier, such as a driver, a consumer, an advertiser, a merchant, or a governmental authority.

According to one embodiment, the communication controller 600 receives from a communication device 20 a request to facilitate a communication in association with a destination identifier that has a primary purpose other than communication. For example, the communication controller 600 may receive a request (including a license plate number and an audible message) from a wireless telephone 22.

The communication controller 600 may then transmit information to a destination device 40 to enable the communication. For example, the communication controller 600 may determine a destination telephone number associated with the destination device 40 (based on a license plate number) and forward an audible message via the destination telephone number. According to another embodiment, the communication controller 600 instead establishes a telephone connection directly between the communication device 20 and the destination device 40 (e.g., without revealing a destination telephone number). A similar approach may be taken with respect to instant messages.

A communication may also be facilitated with respect to a merchant and/or advertiser device 50. For example, the merchant and/or advertiser device 50 may transmit an advertisement to one or more destination devices 40 (e.g., to all automobiles in a competing merchant's parking lot). Similarly, a consumer may use a communication device 20 to transmit a message to the merchant and/or advertiser device 50. In this case, the destination identifier may comprise, for example, a Universal Product Category (UPC) bar code.

The communication controller 600 may determine a communication address associated with a destination identifier using, for example, a locally stored database. According to another embodiment, this determination is instead made via one or more third-party service devices 60. For example, the communication controller 600 may communicate with a third-party service device 60 associated with a wireless telephone service provider to determine a telephone number of a destination device 40.

According to one embodiment, the communication controller 600 also arranges for a payment to be provided in exchange for a communication being enabled. For example, a driver may pay one dollar each time he or she contacts another driver via the communication controller 600. Such a payment may be arranged, for example, via a payment device 70, such as a payment device 70 associated with a credit card, debit card, bank account, and/or digital payment protocol. The payment may be provided by, for example, by a party requesting a communication, a party receiving a communication, and/or a third-party service. The payment may be provided to, for example, the communication controller 600, a party requesting a communication (e.g., when he or she asks to communicate with a merchant), a party receiving a communication, and/or a third-party service. As used herein, a “payment” may be a monetary amount (e.g., on a per-communication basis), a subscription payment (e.g., a party may pay ten dollars each month to enable communications), an offer amount (e.g., a first driver may offer to pay one dollar to a second driver in exchange for accepting a communication), and/or a non-monetary payment (e.g., a party may receive an advertisement in exchange for having a communication enabled).

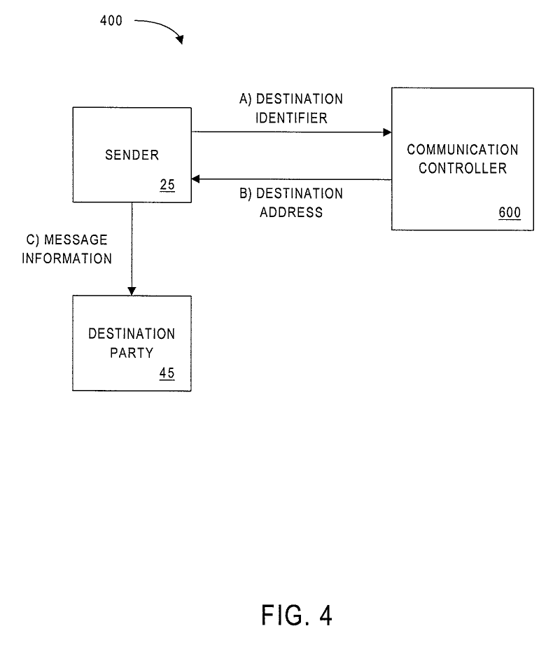

FIG. 4 is an information flow diagram 400 according to one embodiment of the present invention. As shown in FIG. 4, a sender 25 transmits a destination identifier to the communication controller 600 at (A). The communication controller 600 then returns an appropriate destination address to the sender 25 at (B). This lets the sender 25 transmit a message directly to a destination party 45 at (C). Note that the information illustrated in FIG. 4 may be exchanged via a number of different communication networks. For example, the sender 25 may communicate with the communication controller 600 via a first communication network (e.g., the Internet) and with the destination party 45 via a second communication network (e.g., a wireless telephone network).

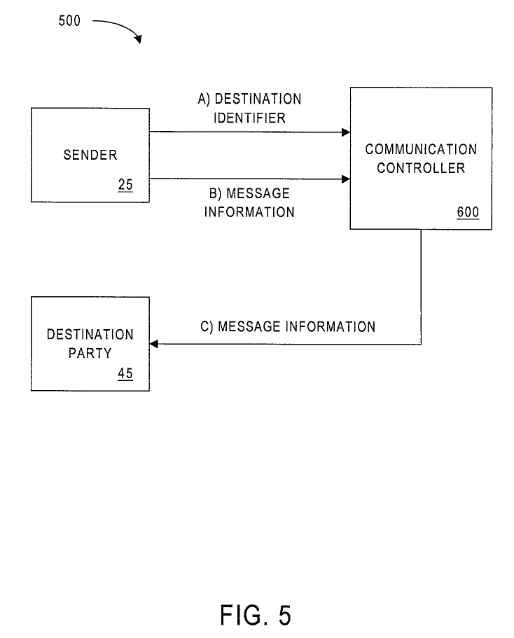

FIG. 5 is an information flow diagram 500 according to another embodiment of the present invention. As before, the sender 25 transmits a destination identifier to the communication controller 600 at (A). In this case, however, the sender also transmits message information to the communication controller 600 at (B). This lets the communication controller 600 forward the message information to the destination party 45 at (C). With this approach, no information about the destination party 45 needs to be provided to the sender 25. According to one embodiment, the communication controller 600 also transmits to the sender 25 a confirmation indicating that the message has been sent to the destination party 45. The destination party 45 may also be allowed to respond to the sender 25 (e.g., either directly or via the communication controller 600).

According to another embodiment, the sender 25 transmits the destination identifier to a first device and the message information to a second device. The first device could then determine the communication address associated with the destination party 25 and forward that information to the second device. The second device could then arrange for the message information to be transmitted to the destination party 25. In this way, the first device may avoid having to receive, store, and/or transmit lengthy message information.

Communication System Examples

Consider Alice, who is driving at dusk when she notices that another driver has forgotten to turn on his or her headlights. She places a wireless telephone call to a communication controller 600 and reads aloud the license plate number of the other driver's automobile. The communication controller 600 determines the other driver's wireless telephone number (e.g., via a speech recognition process and a locally stored database) and establishes a wireless telephone connection between Alice and the other driver. Alice can then remind the other driver to turn on his or her headlights.

As another example, Bob is driving his automobile on street having a 35 mile-per-hour speed limit. A device located at the street detects that Bob is traveling at 45 miles-per-hour and automatically records an image of his license plate number. The device transmits this image to a communication controller 600, which determines Bob's home electronic mail address (e.g., via an optical scanning recognition process and a third-party service). The communication controller 600 then transmits an electronic mail message to Bob asking him to drive more safely.

As still another example, David would like to receive more information about a product he has purchased. He enters the product UPC code into a Web site along with his electronic mail address. A communication controller 600 then forwards David's electronic mail address to the appropriate manufacturer based on the UPC code. The manufacturer then contacts David directly with the appropriate product information.

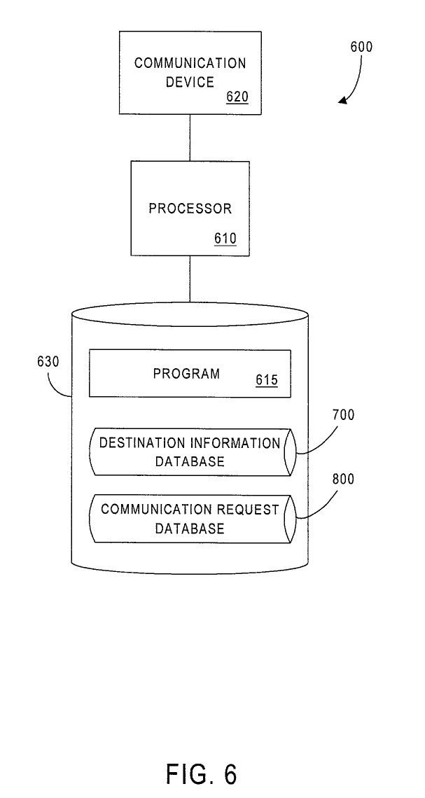

An example of a communication controller 600 that may be used in connection with the communication systems 100, 300 discussed herein will now be described in detail with respect to FIGS. 6 through 8.

Communication Controller

FIG. 6 illustrates a communication controller 600 that is descriptive of the devices shown, for example, in FIGS. 1 and 3 according to an embodiment of the present invention. The communication controller 600 comprises a processor 610, such as one or more INTEL® Pentium® processors, coupled to a communication device 620 configured to communicate via a communication network (not shown in FIG. 6). The communication device 620 may be used to communicate, for example, with one or more communication devices 20, destination devices 40, merchant and/or advertiser devices 50, third-party service devices 60, and/or payment devices 70.

The processor 610 is also in communication with a storage device 630. The storage device 630 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 630 stores a program 615 for controlling the processor 610. The processor 610 performs instructions of the program 615, and thereby operates in accordance with the present invention. For example, the processor 610 may receive a request to facilitate a communication in association with a destination identifier, the destination identifier having a primary purpose other than communication. The processor 610 may also transmit information to enable the communication.

According to another embodiment, the processor 610 receives from a consumer (e.g., someone who has or will provide a payment in exchange for this service) a request to facilitate a communication, the request including a license plate number. The processor 610 determines an electronic mail address associated with the license plate number, and transmits information to enable the communication between the consumer and the electronic mail address. The processor 610 also arranges for the consumer to provide payment of a monetary payment.

According to still another embodiment, the processor 610 receives a communication request including a sender communication address and a destination identifier having a primary purpose other than communication. The processor 610 then transmits the sender communication address to a destination communication address associated with the destination identifier.

In yet another embodiment, the processor 610 receives from a first party a request to facilitate a communication associated with a destination identifier, the destination identifier being associated with a second party (or second party device) and having a purpose other than communication. The processor determines a destination communication address associated with the second party (or second party device) and transmits information associated with the destination communication address to enable communication between the first party and the second party.

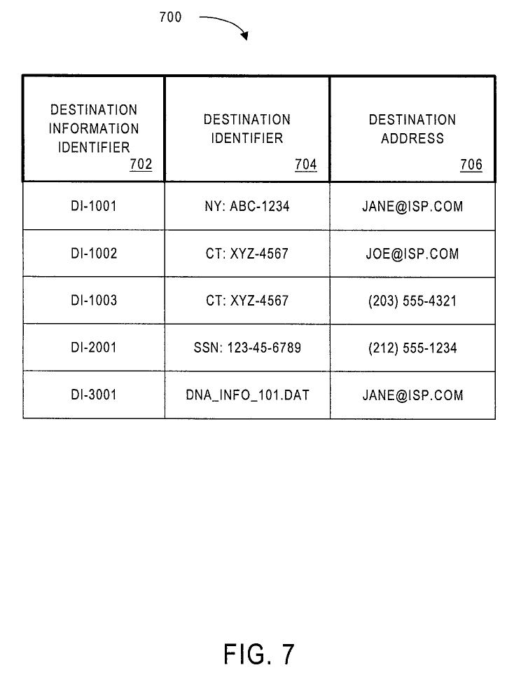

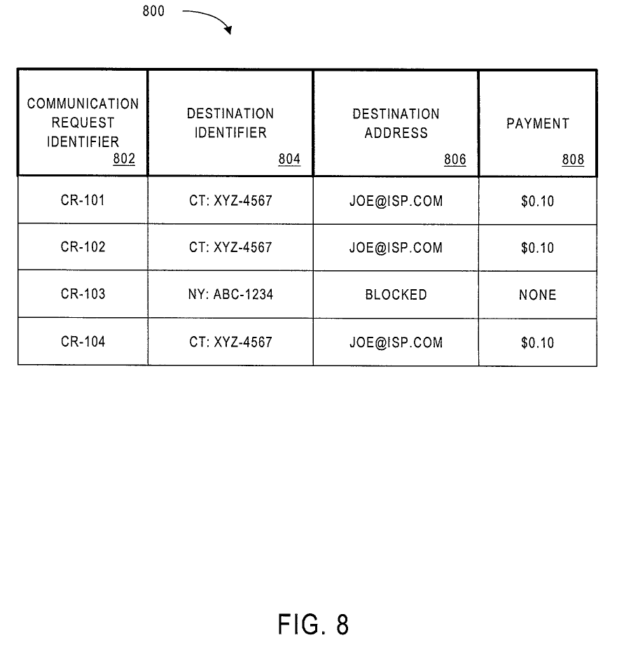

The storage device 630 also stores a destination information database 700 (described with respect to FIG. 7) and a communication request database 800 (described with respect to FIG. 8). The illustrations and accompanying descriptions of the databases presented herein are exemplary, and any number of other database arrangements could be employed besides those suggested by the figures.

Destination Information Database

Referring to FIG. 7, a table represents the destination information database 700 that may be stored at a communication controller 600 according to an embodiment of the present invention. The table includes entries identifying destinations (i e., destination parties and/or destination devices) to which communications may be facilitated. The table also defines a destination information identifier 702, a destination identifier 704, and a destination address 706 for each of the entries. The information in the destination information database 700 may be created and updated, for example, by the communication controller 600 and/or a third-party service (e.g., a wireless telephone service provider).

The destination information identifier 702 may be, for example, an alphanumeric code associated with a particular destination. Note that this may be used by the communication controller 600, for example, as an internal representation of the destination. The destination identifier 704 may represent information having a primary purpose other than communication with that destination. For example, the destination identifier 704 may comprise a license plate number, a Social Security number, or a UPC bar code. The destination address 706 represents a communication address associated with that destination. For example, the destination address 706 may comprise a telephone number, an electronic mail address, or an instant message address associated with that destination. As illustrated by the second and third entries in the destination information database 700, a single destination identifier 704 may be associated with a number of destination addresses 706 (e.g., an electronic mail address and a telephone number).

In addition to the information illustrated in FIG. 7, other information can be stored in the destination information database 700. For example, indications of an automobile's manufacturer and model may be stored in the destination information database 700 along with demographic information associated with the automobile's owner. particular request was blocked (e.g., indicating which of a number of different privacy levels or rules resulted in a request being blocked).

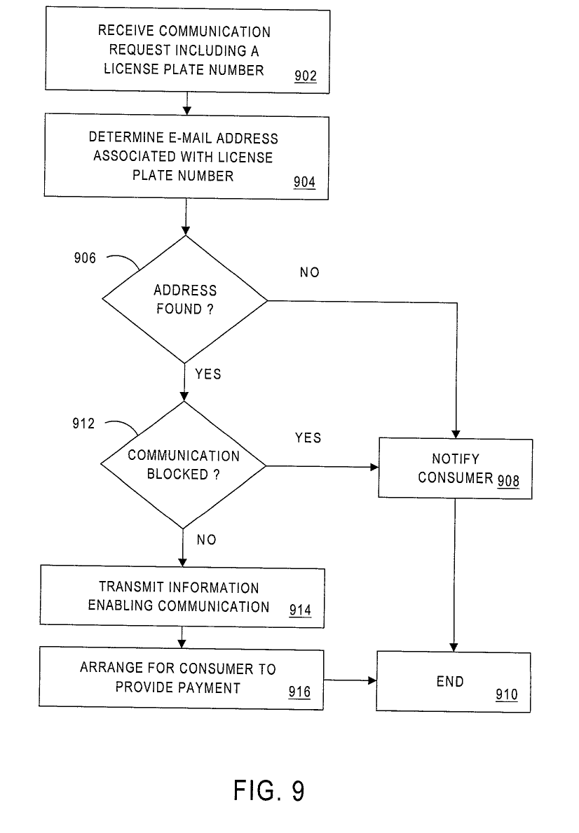

A method that may be used in connection with the communication systems 100, 300 according to an embodiment of the present invention will now be described in detail with respect to FIG. 9.

Communication System Method

FIG. 9 is a flow chart of a computer-implemented method to facilitate an electronic mail message communication associated with an automobile license plate number according to an embodiment of the present invention. The method may be performed, for example, by a communication controller 600.

At 902, a communication request is received from a consumer, the request including a license plate number. For example, a communication controller 600 may receive such a communication request from a consumer's wireless PDA. The communication controller 600 may then generate a communication request identifier 802 and store the license plate number as a destination identifier 804 in the communication request database 800.

An appropriate electronic mail address associated with the license plate number is then determined at 904. For example, the communication controller 600 may determine the license plate number based on the destination identifier 704 and associated destination address 706 stored in the destination information database 700. If no electronic mail address can be found at 906, the consumer is notified that the request cannot be processed at 908 (e.g., by displaying “the license plate number you provided is not listed in our service” via the consumer's wireless PDA). The process then ends at 910.

If an electronic mail address is found, the communication controller 600 determines whether or not the requested communication will be “blocked” at 912. For example, the communication controller 600 may determine if a person associated with the electronic mail address determined 904 has indicated that he or she is not interested in receiving messages via the communication system. If it is determined that the communication will be blocked, the consumer is notified at 908 (e.g., by displaying “the party you are attempting to reach does not accept message from our service” via the consumer's wireless PDA) and the process ends at 910.

If it is determined that the requested communication will not be blocked, the communication controller transmits information to enable the communication between the consumer and the electronic mail address at 914. For example, the communication controller 600 may transmit an indication of the electronic mail address to the consumer. According to another embodiment, the communication controller 600 instead forwards a communication address associated with the consumer (e.g., his or her home telephone number) to the electronic mail address. According to still another embodiment, the communication controller 600 forwards a message from the consumer to the electronic mail address.

At 916, it is arranged for the consumer to provide payment of a monetary payment. For example, the communication controller 600 may arrange for the consumer to pay one dollar in exchange for having a message forwarded to the electronic mail address.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although many of the embodiments described herein are associated with a communication controller 600 facilitating communications, according to another embodiment communication devices 20 instead communicate with each other to perform this function (e.g., a group communication devices 20 may utilize peer-to-peer communications to facilitate communications via destination identifiers).

Moreover, the embodiments described herein are associated with a communication controller 600 performing a number of functions. According to other embodiments, some or all of these functions can instead be performed by any of the other devices described herein. For example, a communication device 20 or a third-party service device 60 may perform some or all of the functions described with respect to the communication controller 600.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating communication, comprising:
receiving from a party a request to facilitate a communication in association with a destination identifier, the destination identifier having a primary purpose other than communication; and
transmitting information to enable the communication.

2. The method of claim 1, wherein the destination identifier is associated with a communication address, and said transmitting comprises transmitting information to the communication address.

3. The method of claim 2, further comprising:
determining the communication address based on the destination identifier.

4. The method of claim 3, wherein said determining is performed via at least one of: (i) retrieving a pre-stored communication address based on the destination identifier, and (ii) receiving the communication address from a third-party service.

5. The method of claim 2, wherein the communication address comprises at least one of: (i) an electronic mail address, (ii) an instant message address, (iii) an Internet Protocol address, (iv) a telephone number, and (v) Bluetooth information.

6. The method of claim 1, wherein the destination identifier comprises at least one of: (i) an automobile identifier, (ii) a license plate number, (iii) a governmental identifier, (iv) a Social Security number, (v) a credit card number, (vi) biological information, (vii) genetic information, (viii) a facial image, (ix) a retinal pattern, (x) a fingerprint, and (xi) a voice print.

7. The method of claim 1, wherein the destination identifier is associated with a plurality of communication addresses.

8. The method of claim 1, wherein a plurality of destination identifiers are associated with a communication address.

9. The method of claim 1, wherein the destination identifier comprises at least one of: (i) text information, (ii) audio information, and (iii) image information.

10. The method of claim 1, wherein the party comprises a consumer.

11. The method of claim 1, wherein the party comprises at least one of: (i) an advertiser, (ii) an enterprise, (iii) a merchant, (iv) a governmental authority, (v) a security service.

12. The method of claim 1, wherein the destination identifier comprises an automobile identifier, and said receiving comprises:
receiving automobile identifiers associated with at least one of: (i) automobiles associated with a pre-determined area, (ii) automobiles moving through a pre-determined area, and (iii) automobiles satisfying a pre-determined condition.

13. The method of claim 1, wherein the request includes at least one of: (i) the destination identifier, (ii) a communication address preference, (iii) an identifier of the party associated with the request, (iv) a communication address of the party associated with the request, (v) message information, (vi) text message information, (vii) audio message information, (viii) image message information, (ix) advertisement information, and (x) payment information.

14. The method of claim 1, wherein said transmitting comprises:
determining a communication address associated with the destination identifier; and
transmitting the communication address to the party associated with the request.

15. The method of claim 1, wherein the request includes message information, and said transmitting comprises:
determining a communication address associated with the destination identifier; and
transmitting the message information to the communication address.

16. The method of claim 15, further comprising:
transmitting to the party associated with the request a confirmation indicating that the communication has been facilitated.

17. The method of claim 1, further comprising:
determining supplemental information associated with the destination identifier; and
transmitting the supplemental information.

18. The method of claim 17, wherein the supplemental information comprises at least one of: (i) demographic information, (ii) preference information, (iii) location information, (iv) location history information, and (v) activity information.

19. The method of claim 1, wherein the destination identifier is associated with one of: (i) a pre-determined destination party, and (ii) a set of destination parties.

20. The method of claim 1, further comprising:
arranging for a payment to be provided in exchange for the communication being enabled.

21. The method of claim 20, wherein the payment is provided by at least one of: (i) the party associated with the request, (ii) a party associated with the destination identifier, (iii) a third-party service.

22. The method of claim 20, wherein the payment is associated with at least one of: (i) a monetary amount, (ii) a subscription payment, (iii) an offer amount, and (iv) a non-monetary payment.

23. The method of claim 1, further comprising:
determining if the communication will be enabled based on the destination identifier.

24. The method of claim 1, wherein at least one of said receiving and said transmitting are performed via at least one of: (i) a telephone network, (ii) a wireless network, (iii) a Bluetooth network, (iv) an Internet Protocol network, (v) the Internet, (vi) a public network, and (vii) a private network.

25. The method of claim 24, wherein said receiving is performed via a first communication network and said transmitting is performed via a second communication network.

26. The method of claim 1, wherein at least one of said receiving and said transmitting are performed via at least one of: (i) a consumer device, (ii) an automobile device, (iii) an advertiser device, (iv) a merchant device, (v) a computer, (vi) a portable computing device, (vii) a personal digital assistant, (viii) a telephone, (ix) a wireless telephone, (x) a kiosk, (xi) a pager, and (xii) a camera.

27. A computer-implemented method of facilitating communication, comprising:
receiving from a consumer a request to facilitate a communication, the request including a license plate number;
determining an electronic mail address associated with the license plate number;
transmitting information to enable the communication between the consumer and the electronic mail address; and
arranging for the consumer to provide payment of a monetary payment.

28. An apparatus, comprising:
a processor; and
a storage device in communication with said processor and storing instructions adapted to be executed by said processor to:
receive from a party a request to facilitate a communication in association with a destination identifier, the destination identifier having a primary purpose other than communication, and
transmit information to enable the communication.

29. The apparatus of claim 28, wherein said storage device further stores at least one of: (i) a destination information database, and (ii) a communication request database.

30. The apparatus of claim 28, further comprising:
a communication device coupled to said processor and adapted to communicate with at least one of: (i) a communication device, (ii) a consumer device, (iii) a destination device, (iv) a third party service device, (v) a communication controller, and (vi) a payment device.

31. A medium storing instructions adapted to be executed by a processor to perform a method of facilitating communication, said method comprising:
receiving from a party a request to facilitate a communication in association with a destination identifier, the destination identifier having a primary purpose other than communication; and
transmitting information to enable the communication.

32. A method performed by a party to facilitate communication, comprising:
transmitting a request to facilitate a communication, the request including a destination identifier having a primary purpose other than communication; and
arranging to provide payment in exchange for having the communication enabled.

33. A method of facilitating communication, comprising:
receiving from a sender a communication request including a sender communication address and a destination identifier having a primary purpose other than communication; and
transmitting the sender communication address to a destination communication address associated with the destination identifier.

34. A method of facilitating communication, comprising:
receiving from a first party a request to facilitate a communication associated with a destination identifier, the destination identifier being associated with a second party and having a purpose other than communication;
determining a destination communication address associated with the second party; and
transmitting information associated with the destination communication address to enable communication between the first party and the second party.
